(19) United States
(12) Patent Application Publication
(10) Pub. No.: US 2004/0203776 A1
(43) Pub. Date: Oct. 14, 2004

(54) Method for registering greetings in mobile terminal

(76) Inventor: Yong-Ok Jun, Ichon-shi (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,422

(22) Filed: Dec. 31, 2003

(30) Foreign Application Priority Data
Apr. 9, 2003 (KR) 2003-22295

(51) Int. Cl. H04Q 7/20

(52) U.S. Cl. 455/435.1

(57) ABSTRACT

Provided is a method for registering greetings in a mobile terminal to convey the greetings to a caller by performing expanded termination, while the mobile terminal is turned off. According to the greetings registration method of the present research, greetings for the mobile terminal can be registered easily by transmitting text or voice data to a base station. The method includes the steps of: a) determining whether a termination request inputted by a user of the mobile terminal is for expanded termination or basic termination; b) if the termination request is for the basic termination, performing a basic termination process; and c) if the termination request is for the expanded termination, performing an expanded termination process.

### FIELD OF THE INVENTION

The present invention relates to a method for registering greetings for a mobile terminal; and, more particularly, to a method for registering greetings for a caller in the mobile terminal by transmitting short text data or voice data to a base station to convey the greetings to a caller while a user of the mobile terminal cannot answer the phone call.

### DESCRIPTION OF RELATED ART

A user of a mobile terminal may be in conference or class and he cannot answer a call. So, the user wants a service that can convey a greetings message to a caller while his mobile terminal is turned off. Conventional greetings services, however, require many steps to register greetings for the caller. First, the user should make a call at a specific phone number for greetings registration service and he should perform several more steps to register greetings. These procedures require lots of time, effort, and even service charges for using the call. The procedural complexity has kept mobile terminal users away from the conventional greetings registration service and this has made business persons lose opportunity for profits.

### SUMMARY OF THE INVENTION

It is, therefore, an object of the present invention to provide a method for registering greetings in a mobile communication terminal by establishing and executing an expanded termination function and transmitting a short text message or voice message to a base station so that the message is conveyed to a caller while a mobile terminal user cannot answer a call.

In accordance with an aspect of the present invention, there is provided a method for registering greetings in a mobile terminal, including the steps of: a) determining whether a termination request inputted by a user of the mobile terminal is for expanded termination or basic termination; b) if the termination request is for the basic termination, performing a basic termination process; and c) if the termination request is for the expanded termination, performing an expanded termination process.

In accordance with another aspect of the present invention, there is provided a method for registering greetings in a mobile terminal, including the steps of: a) determining whether a termination mode is an expanded termination or a basic termination when a termination signal is received from the mobile terminal; b) if the termination mode is the basic termination, storing information indicating that the mobile terminal is power-off; and c) if the termination mode is the expanded termination, registering a greeting for the mobile station based on greeting information.

In accordance with another aspect of the present invention, there is provided a method for registering greetings in a mobile terminal, including the steps of: a) receiving a termination mode from a user; b) determining whether a termination mode is for an expanded termination or a basic termination; c) if the termination mode is for the expanded termination, determining whether greetings are to be edited or not; and d) if the greetings are to be edited, performing greeting conversion process.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a greetings server connected to a mobile terminal and base stations to which the present invention is applied;

FIG. 2 is a flowchart illustrating a method for establishing an expanded termination function in the mobile terminal in accordance with an embodiment of the present invention;

FIG. 3A is a flowchart describing a method of executing the expanded termination in accordance with an embodiment of the present invention;

FIG. 3B is a flowchart depicting a method of changing greetings in the expanded termination process of FIG. 2 in accordance with an embodiment of the present invention; and

FIG. 4 is a flowchart illustrating a function of a greetings registration server for the mobile terminal in accordance with an embodiment of the present invention.

### DETAILED DESCRIPTION OF THE INVENTION

Other objects and aspects of the invention will become apparent from the following description of the embodiments with reference to the accompanying drawings, which is set forth hereinafter.

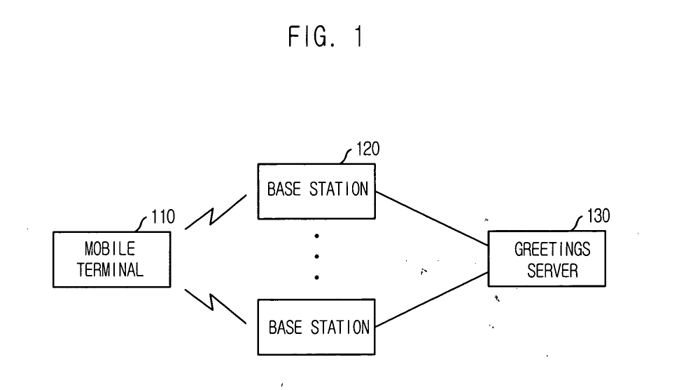

FIG. 1 is a block diagram showing a greetings server connected to a mobile terminal and base stations to which the present invention is applied. Referring to FIG. 1, a mobile terminal 110 communicates with a nearby base station 120 which is connected to a greetings server 130. The mobile terminal 110 communicates with the base station 120 through wireless channel and the base station 120 communicates with the greetings server 130 through wired line. The greetings server 130 registers greetings for a corresponding phone number.

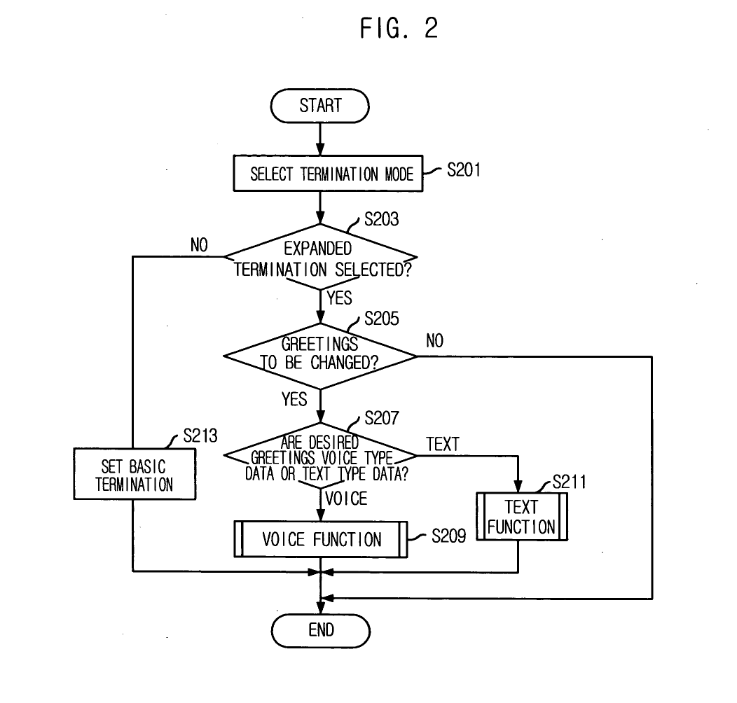

FIG. 2 is a flowchart illustrating a method of establishing an expanded termination function in the mobile terminal in accordance with an embodiment of the present invention.

As shown, at step S201, a termination request signal is received, i.e., a user of the mobile terminal presses a termination key or selects corresponding optional instruction for the expanded termination in MENU. The function key for expanded termination can be added to the mobile terminal. Then, at step S203, the mobile terminal inquires the user whether the user would select the expanded termination other than basic termination. Here, the expanded termination includes functions of transmitting notification of the expanded termination, transmitting greetings to a caller and transmitting a greetings message recoded by user to the base station when the user changes greeting message.

If the expanded termination is not selected at the step S203, at step S213, basic termination is set.

If the expanded termination is selected at step S203, at step S205, it is determined whether the greetings in an existing message list are to be changed or deleted. And also, it is determined whether a new greeting message is added.

If the user does not want to change the greetings, the process is end. If the greetings are to be changed, at step S207, it is checked whether the type of the changed greetings is a voice type or a text type. The voice type means that greetings are recorded by the user himself, transmitted to the base station, and then registered in the base station. The text type means that a short text message is typed by the user and registered in the base station after transmitted to the base station.

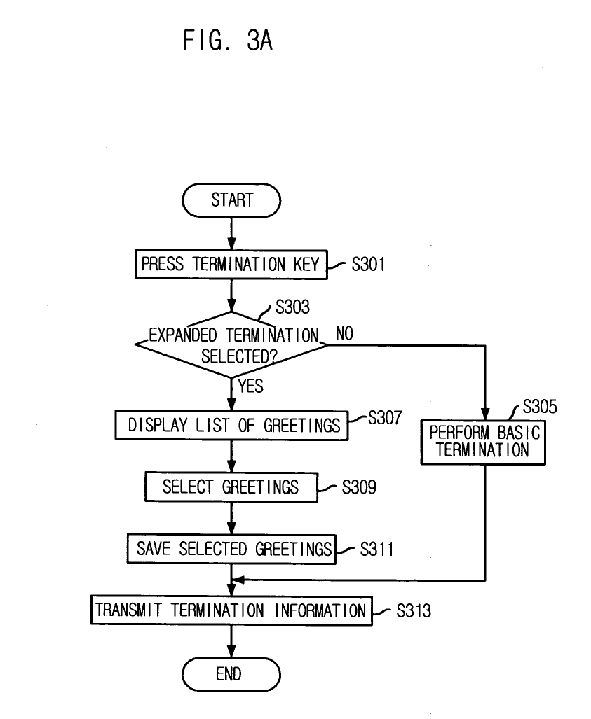

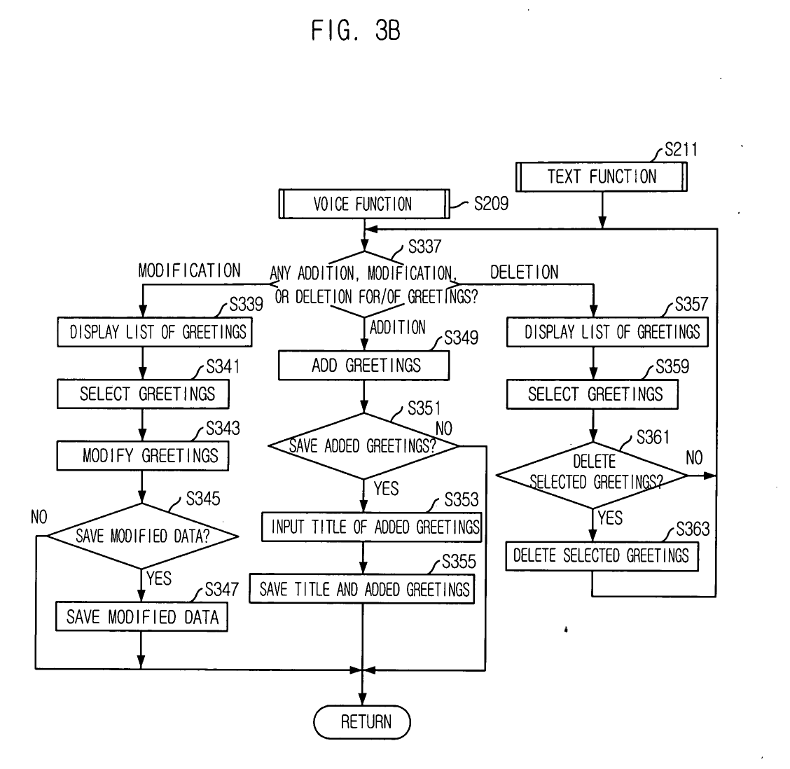

According to the data type selected by the user at the step S207, a voice function or a text function is performed. If the data type is voice type, the voice function is performed at step 209. Also, if the data type is text type, a text function is performed at step S211. Detailed description of the voice function and the text function will be described with reference to FIG. 3B.

FIG. 3A is a flowchart describing a method of executing an expanded termination in accordance with an embodiment of the present invention. As shown, when termination request signal is received, i.e., the user of the mobile terminal presses the termination key to turn off the mobile terminal at step S301, at step S303, it is checked whether the expanded termination, which is established in the process of FIG. 2, is selected or not.

If the expanded termination function is not selected, at step S305, the basic termination is performed, i.e., a power-down-registration message is transmitted to the base station. The basic termination means a conventional termination method, which is different from the termination method of the present invention. Since the power-down-registration is described in the Interim Standard (IS)-95B and IS-2000, and therefore, for easy description, more detailed description on the power-down-registration message will be omitted.

The termination of the mobile terminal is informed to a greetings server by using an access channel so that the server should not secure a channel unnecessarily. This way, overload of the mobile communication system can be reduced.

Table 1 below shows the operation of the power-down-registration in the access channel. When the mobile terminal transmits a message ‘reg_type 2’ to the base station, the server connected to the base station recognizes that the mobile terminal is turned power-off.

TABLE 1
Registration Message (AC)
06/02/1998 08:46:20.025 [3E] ACCESS CAI

Registration Message

ack_seq 7, msg_seq 0, ack_req 1, valid_ack 0, ack_type 0
MIN (0×384) 5A2B84 = (011) 471-0011
esn 0×B07A0001
auth_mode 0
reg_type 2 (Power-Down)
slot_cycle_index 2
mob_p_rev 2
scm 0×2a
mob_term 1

Meanwhile, if the expanded termination is selected at the step S303, a list of greetings is displayed so as to select one of the greetings at step S307.

At step S309, if one of the greetings on the list is selected by the user, the mobile terminal saves the selected greetings at step S311. At step S315, the mobile terminal transmits termination information which indicates the selected greeting and the expanded termination and is turned off.

FIG. 3B is a flowchart depicting a method of converting a greetings used in the expanded termination process of FIG. 2 in accordance with an embodiment of the present invention.

As mentioned above referring to FIG. 2, if the voice data type is preferred to change by the user, at step S333, a voice function is called for voice recording. If the text data type is preferred to change by the user, at step S335, a text function is called.

Whether the called function is a voice function or a text function, at step S337, the mobile terminal inquires the user if he would add, modify, or delete greetings with respect to the called function whether the called function is a voice function or a text function.

If the user selects to add greetings, at step S349, voice is recorded or a short text message is drawn up by the user. At step S351, it is determined whether to save the voice data or the text data. If the voice or text data is determined to be saved, at step S355, the user inputs a title of the voice or text data, saves the voice or text data with the title at step S357 and ends the process. If the user does not want to save the voice or text data at the step S351, he does not save the voice or text data and ends the process.

If the user selects to modify greetings, at step S339, the mobile terminal displays to the user a list of greetings, both voice and text data that have been saved in the mobile terminal. Subsequently, at step S341, the user selects a voice or text data out of the list and, at step S343, the selected voice or text data is modified. Since the modification is performed on the data, the existing title of the data remains unchanged. Therefore, the step of inputting a title is omitted in the modification process.

At step S345, it is determined whether the modified data is to be saved or not. If the modified data needs to be saved, at step S347, it is saved and the process is ended. If the modified data needs not be saved, the process is ended directly.

If the user selects to delete greetings, at step S357, the mobile terminal displays to the user the list of greetings, both voice and text data that have been saved in the mobile terminal.

At step S359, the user selects greetings to be deleted and, at step S361, the mobile terminal inquires the user whether it should delete the selected greetings. If the user answers ‘yes’, at step S363, the mobile terminal performs deletion. Subsequently, the logic flow goes to the step S337 where the mobile terminal inquires the user whether he would add, modify, or delete greetings with respect to the called function whether the called function is a voice function or a text function, and repeats the sequential process.

Even if the user does not want deletion, the process can be repeated from the step S337 where the mobile terminal inquires the user to add, modify, or delete greetings.

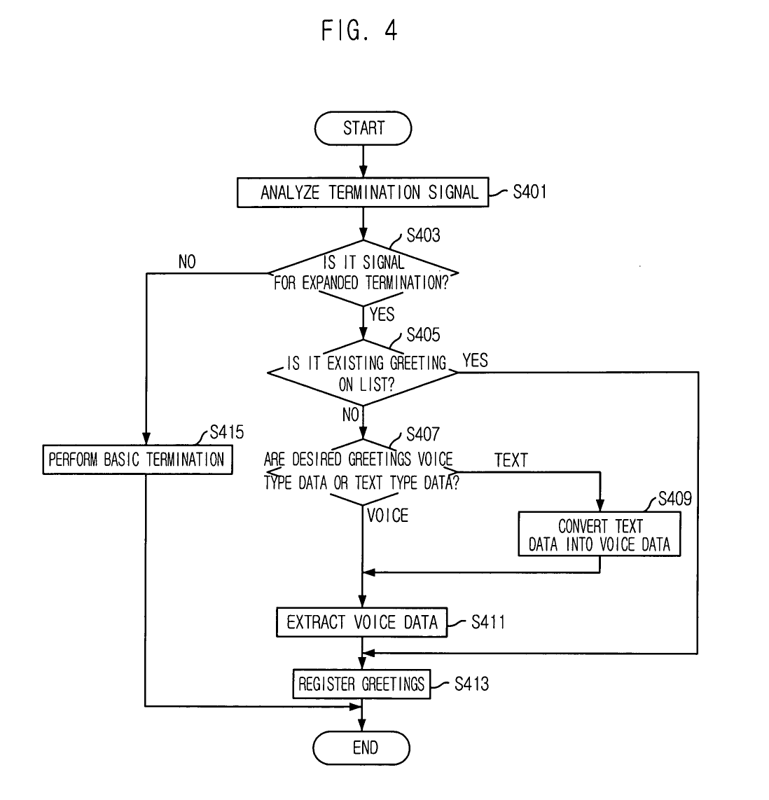

FIG. 4 is a flowchart illustrating a function of a greetings registration server for the mobile terminal in accordance with an embodiment of the present invention. The drawing shows a process that is performed when the greetings server connected to the base station receives data transmitted by the user.

At step S401, when the greetings server receives data, it analyzes a termination signal. At step S403, it is checked if the termination signal is for expanded termination including greetings. If the termination signal is not for expanded termination, at step S415, the conventional basic termination is performed. That is, no greetings data is registered in the greetings server.

If the termination signal is for expanded termination at step S403, it is checked whether a signal transmitted to the greetings server is one of existing greetings on the list or not at step S405. If it is one of existing greetings on the list, the greetings server registers the greeting for the mobile terminal at step S413.

If it is not one of existing greetings on the list, at step S407, it is checked whether the greeting included in the termination signal is a voice data or a text data. If the data is a text data, at step S409, the text data is converted into a voice data. Since a program for converting text data into voice data can be easily obtained, the conversion process and principles will not be described herein.

If the voice type data is obtained by conversion at the step S409 or if the data received by the greetings server is a voice type data, at step S411, voice data are extracted.

Subsequently, at step S413, the greetings server registers the extracted voice data as the greetings for the mobile terminal.

As described above, greetings can be registered easily by expanding the conventional termination function, i.e., transmitting the greetings data together with the power-down-registration message, even when the mobile terminal is terminated in the conventional termination method.

In accordance with the present invention, termination information including greetings is transmitted to the greetings server through the base station by establishing the expanded termination function in the mobile terminal and then performing the expanded termination when the termination key is pressed. The greetings server extracts voice data out of the information it has received and inserts the voice data as the greetings for the mobile terminal.

The greetings registration method of the present invention can reduce time and effort for registering greetings and cut the mobile phone service charges by transmitting the greetings along with the termination information. Also, it makes the user convenient to register the greetings. The convenience leads frequent use of the greetings registration service, to thereby increase service provider's profits.

While the present invention has been described with respect to certain preferred embodiments, it will be apparent to those skilled in the art that various changes and modifications may be made without departing from the scope of the invention as defined in the following claims.

What is claimed is:

1. A method for registering greetings in a mobile terminal, comprising the steps of:
a) determining whether a termination request inputted by a user of the mobile terminal is for expanded termination or basic termination;
b) if the termination request is for the basic termination, performing a basic termination process; and
c) if the termination request is for the expanded termination, performing an expanded termination process.

2. The method as recited in claim 1, wherein the basic termination process includes the step of turning the mobile terminal power-off.

3. The method as recited in claim 1, wherein the step c) includes the steps of:
c-a) selecting one of greetings; and
c-b) notifying a mobile communication system that the expanded termination is requested and transmitting greeting information which relates to the selected greetings to the mobile communication system.

4. The method as recited in claim 3, wherein the step c) further includes the step of: c-c) turning the mobile terminal power-off.

5. The method as recited in claim 3, wherein the mobile communication system prevents the mobile terminal from receiving a call and transmits the greetings to a caller.

6. The method as recited in claim 3, wherein in the expanded termination, the mobile terminal is power-on and remains in a waiting state but the reception of a call is prevented.

7. A method for registering greetings in a mobile terminal, comprising the steps of:
a) determining whether a termination mode is an expanded termination or a basic termination when a termination signal is received from the mobile terminal;
b) if the termination mode is the basic termination, storing information indicating that the mobile terminal is power-off; and
c) if the termination mode is the expanded termination, registering a greeting for the mobile station based on greeting information.

8. The method as recited in claim 7, wherein the step c) includes the steps of:
c-a) determining whether the greeting to be registered is a new greeting or not;
c-b) if the greeting to be registered is the new greeting, determining whether the new greeting is voice data or text data; and
c-c) if the new greeting is voice data, extracting the voice data, and if the new greeting is text data, converting the text data to voice data and extracting the voice data.

9. The method as recited in claim 7, wherein the mobile communication system prevents the mobile terminal from receiving a call and transmits the greetings to a caller.

10. The method as recited in claim 7, wherein in the expanded termination, the mobile terminal is power-on and remains in a waiting state but the reception of a call is prevented.

11. A method for registering greetings in a mobile terminal, comprising the steps of:
a) receiving a termination mode from a user;
b) determining whether a termination mode is for an expanded termination or a basic termination;
c) if the termination mode is for the expanded termination, determining whether greetings are to be edited or not; and
d) if the greetings are to be edited, performing greeting conversion process.

12. The method as recited in claim 11, wherein the step d) includes the step steps of:
determining whether the greeting is voice type data or text type data;
calling a voice function or a text function corresponding to the data type; and
performing one of addition, modification and deletion of the greetings.

13. The method as recited in claim 11, wherein in the expanded termination, the mobile terminal is power-on and remains in a waiting state but the reception of a call is prevented.

14. The method as recited in claim 11, wherein in the expanded termination process, the mobile terminal is turned power-off.
